(19) United States
(12) Patent Application Publication
(10) Pub. No.: US 2002/0112998 A1
(43) Pub. Date: Aug. 22, 2002

(54) Hydro cyclone with elongate inlet

(75) Inventor: Jeremy Brett Bosman, Kempton Park (ZA)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(73) Assignee: MULTOTEC PROCESS EQUIPMENT (PROPRIETARY) LIMITED, Kempton Park (ZA)

(21) Appl. No.: 10/044,850

(22) Filed: Nov. 7, 2001

(30) Foreign Application Priority Data
Nov. 9, 2000 (ZA) PROV. 2000/4678

(51) Int. Cl. B04C 5/04

(52) U.S. Cl. 209/734; 209/717; 209/146; 209/719

(57) ABSTRACT

The invention provides a cyclone comprising a generally cylindrical inlet head into which a vortex finder extends co-axially, and from which a tubular section extends opposed to the vortex finder, a generally tangentially disposed inlet for introducing raw material into the inlet head, the tangential inlet being elongated at the zone of its junction with the inlet head to define a major outer wall and a major inner wall, the major outer wall merging with the wall of the cylindrical inlet head generally tangentially at such junction, while the major inner wall diverges towards the axis of the inlet head at each junction.

### FIELD OF THE INVENTION

This invention relates to a hydro-cyclone.

### DESCRIPTION OF PRIOR ART

Hydro-cyclones are widely used in the mineral processing industry for separating coarse and fine fractions of mineral pulps and slurries. Conventional hydro-cyclones comprise a cylindrical inlet head into which raw material is fed generally tangentially, so that circular motions is imparted to the material in the inlet chamber. A light fraction overflow is extracted from the inlet chambers through a vortex finder, which extends co-axially into the inlet and which leads to an outlet. A cone formation depends from the inlet chamber in a direction opposed to the vortex finder and terminates at its remote end in an outlet for a heavy fraction or underflow. With conventional hydro-cyclones, the amount of flow which passes through the cyclone for a given pressure differential, is limited by a number of criteria. Various inlet designs have been attempted in order to maximize efficiencies and flow rate. These include involute and evolute structures and inlet structures which are scrolled helically downwardly about the inlet chamber. Certain of these structures provide an increased efficiency, but such structures are also more complex and costly to produce.

### OBJECT OF THE INVENTION

It is an object of the present invention to provide an arrangement which will be relatively cost effective to produce, yet functionally efficient.

### SUMMARY OF THE INVENTION

According to the present invention, a cyclone comprises a generally cylindrical inlet head into which a vortex finder extends co-axially, and from which a tubular section extends opposed to the vortex finder, a generally tangentially disposed inlet for introducing raw material into the inlet head, the tangential inlet being elongated at the zone of its junction with the inlet head to define an outer and an inner major wall, the major outer wall thereof merging with the wall of the cylindrical inlet head generally tangentially, while the major inner wall diverges towards the axis of the inlet head.

Further according to the invention, the major inner wall diverges through a curvature or radius at the junction with the wall of the inlet head.

In a preferred arrangement, the elongated inlet will be generally rectilinear or ribbon-like and have a length to width ratio of between 2 to 1 and 10 to 1. Preferably the ratio will be in the order of 5 to 1.

Also according to the invention, the ratio of the diameter of the inlet head in relation to the radius of the major inner wall of the inlet will be between 5 to 1 and 100 to 1. In a preferred arrangement, the ratio will be in the order of 20 to 1 but can vary in accordance with feedstock characteristics. Thus with an inlet head with a diameter of 570 mm the radius of the curvature of the major inner wall will preferably range between 15 mm and 50 mm.

### BRIEF DESCRIPTION OF THE DRAWINGS

In order more clearly to illustrate the invention, an embodiment thereof is described hereunder purely by way of example with reference to the accompanying drawings wherein:

FIG. A is a schematic sectioned elevation of a conventional prior art cyclone;

FIG. 1 is an illustration of the basic structure of a cyclone in accordance with the invention;

FIG. 2 is a partially exploded perspective view which illustrates the inlet head of the invention;

FIG. 3 is a schematic illustration of the basic configuration of the inlet head in FIG. 2;

FIG. 4 is a schematic plan view of computer simulated flow pattern in the inlet head of the cyclone of FIG. 1 in accordance with the invention;

FIG. 5 is an enlargement of the flow pattern in FIG. 4 at the inlet zone of the inlet head of the cyclone; and

FIG. 6 is a graphic representation of capacity and inlet corner radius of a cyclone in accordance with the invention.

FIG. 7 is a table showing comparative performance between the cyclone of the invention and that of a high cost and high performance conventional scrolled evolute-type cyclone.

### DETAILED DESCRIPTION OF THE DRAWINGS

Referring to the drawings, a conventional prior art the cyclone 10 is illustrated in FIG. A and comprises a cylindrical inlet head 11 into which raw material 21 in the form of a slurry or pulp is fed via an inlet duct 18 which meets the inlet head 11 generally tangentially. A rotary swirling motion is thus imparted to material entering the inlet head 11 causing separation between a coarse and a fine fraction of suspended particles. The fine fraction 21 is extracted via a vortex finder 16 which projects axially into the inlet head 11 and is connected to an overflow outlet 17. The coarse fraction spirals downwardly in a cone structure 13, 14, which depends from the inlet head 11. The coarse fraction 19 thus reports to the base of the cone formation 13, 14, where it is extracted through an outlet spigot 15.

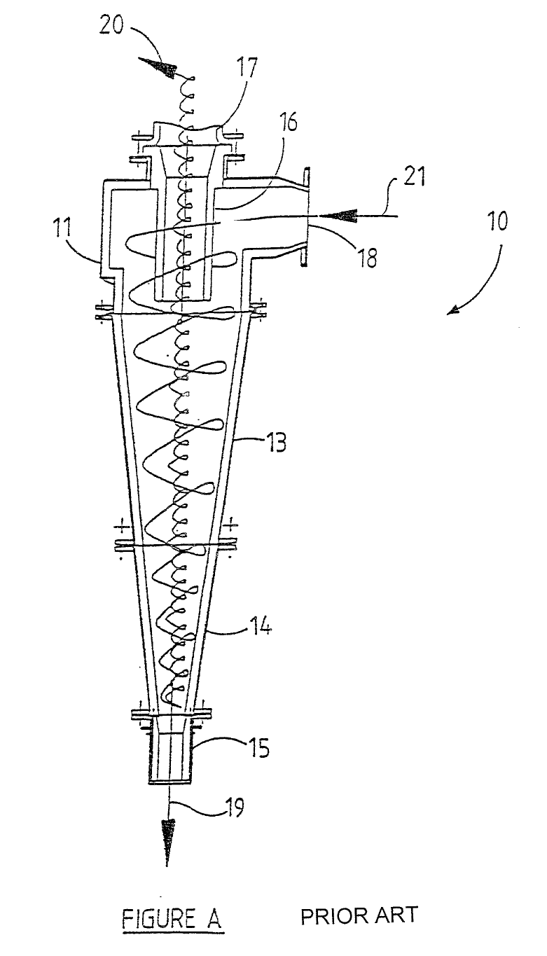

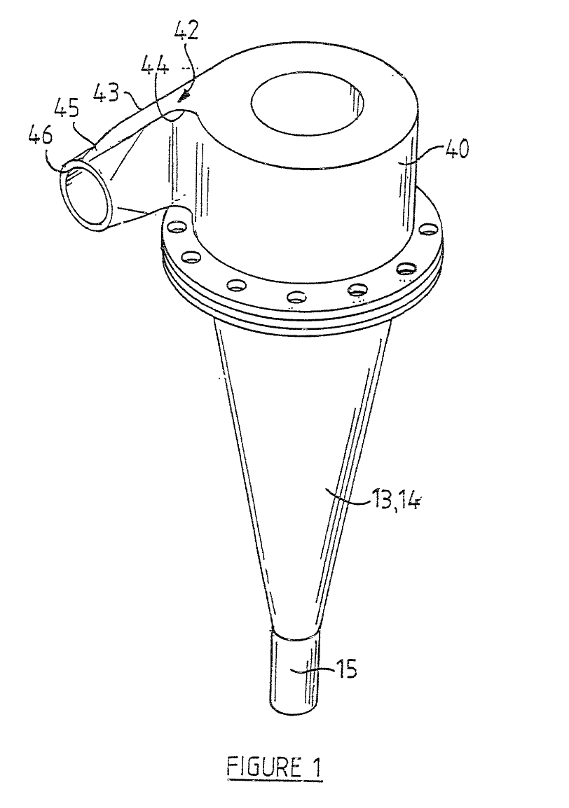

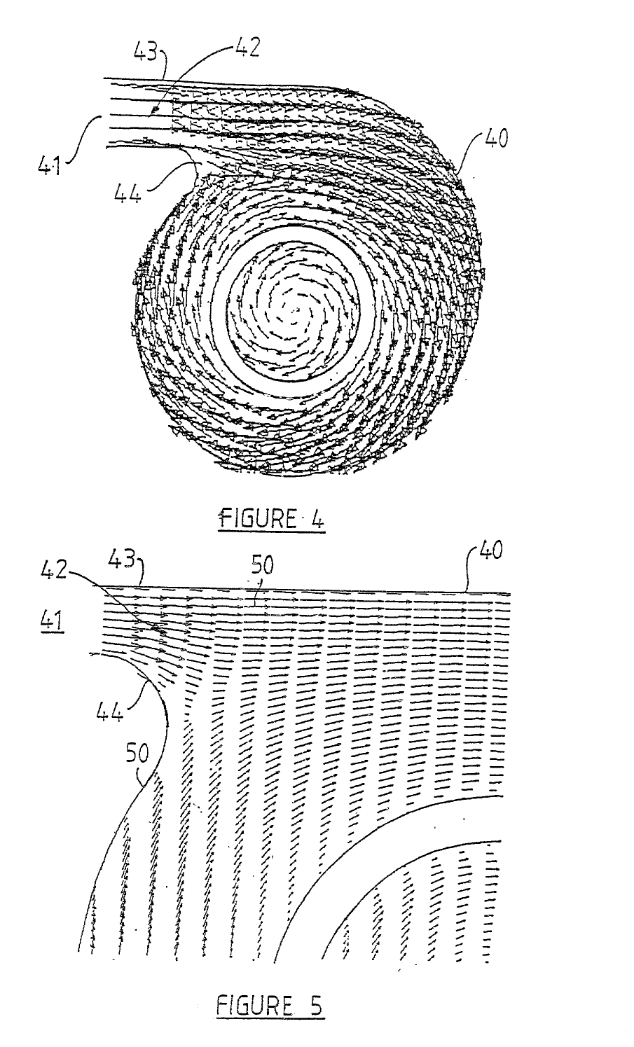

Referring to FIGS. 1 to 5, a cyclone 30 in accordance with the invention is illustrated, and where applicable the same numerals are employed as in the conventional cyclone illustrated in FIG. A.

The cyclone 30 of the invention is characterized in an inlet duct 46 which defines an elongated or ribbon-like aperture 41 in cross-section at its junction 42 with the cylindrical inlet head 40. In the arrangement illustrated, the elongated slot 41 at the inlet head 40 is substantially of a rectangular configuration, and the invention envisages that the ratio between the major axis 41a and the minor axis 41b of the rectangular shape will be between 2 to 1, and 10 to 1, preferably in the order of 5 to 1.

It is a special further feature of the invention that the outer wall 43 of the inlet slot 41 will merge substantially tangentially with the wall of the cylindrical inlet head 40, while the inner wall 44, which is disposed nearest the axis of the inlet head 40, will diverge outwardly towards the axis of the inlet head 40. Preferably the divergent zone 44 will be curved or radiused where it joins the wall of the inlet head 40. The invention provides that the ratio between the cross-sectional diameter of the inlet head 40, and the radius of the curved junction zone between the inlet slot 41 and the wall of the inlet head, will be between 5 to 1 and 100 to 1, typically in the order of 20 to 1.

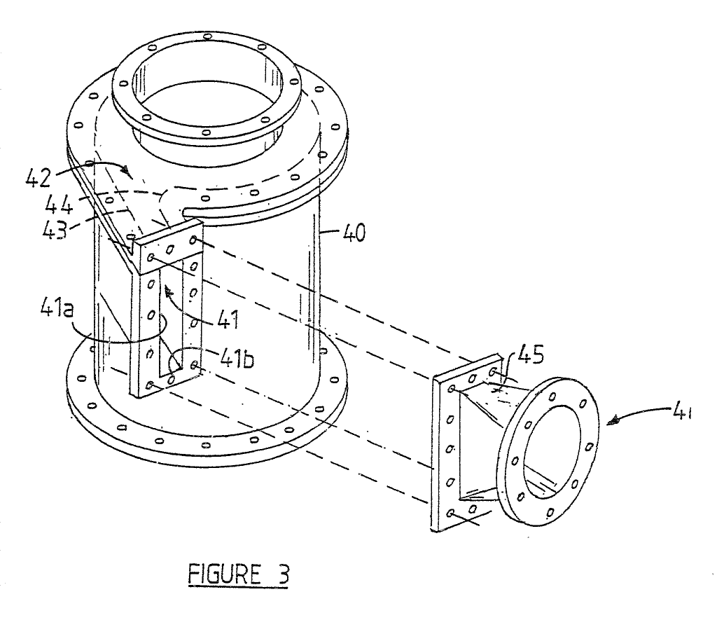

FIG. 4 illustrates a computer simulation of the flow pattern in the inlet head 40, viewed on a cross-section through the inlet duct 46. The arrows 50 shown in the illustration, indicate the velocity of particles flowing in the inlet head 40 and it will be noted that flow from the inlet duct 41 merges evenly with flow in the inlet head 40, and with negligible turbulence. There is moreover a minimal directional change in the circular flow within the inlet head 40 at the junction 42 between the inlet duct 41 and inlet head 40.

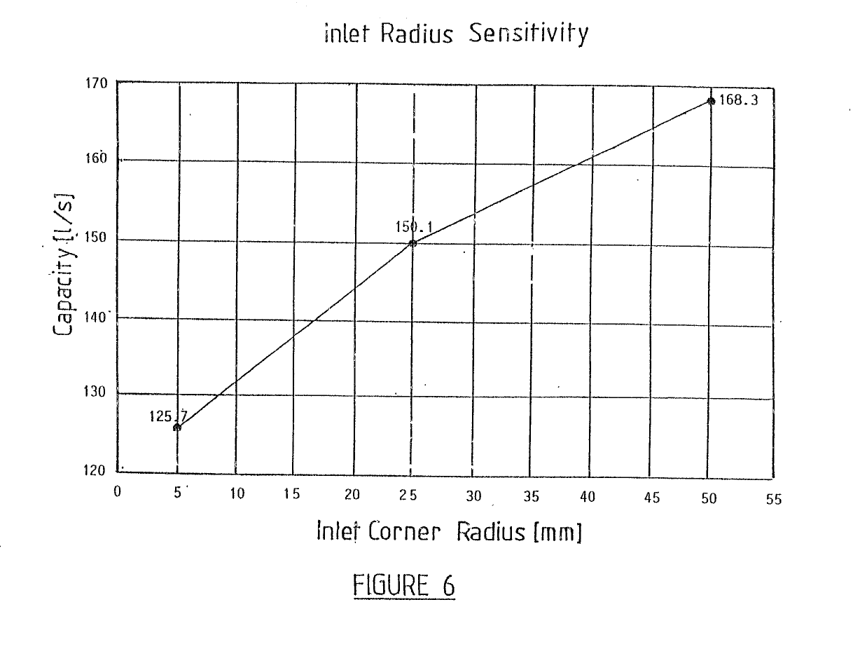

FIG. 6 is a graphic representation of the performance of a cyclone 30 in accordance with the invention with an inlet head 40 of 570 mm, cross-sectional diameter. The graph shows the capacity of the cyclone 30 in relation to the divergence or radius 44 of the junction between the inlet slot 41 and wall of the inlet head 40. It will be noted that the capacity of the cyclone 30 increases in relation to an increase in the radius 44. The simulated experimental results in the graph illustrate the results of a radius ranging from 5 mm to 50 mm for an inlet head 40 diameter of 570 mm as stated above. It will be understood that it is not intended to limit the scope of the invention to the experimental configurations set out in the graph, FIG. 6, and the diverging or rounded junction 44 could be of a larger radius, within practical limits.

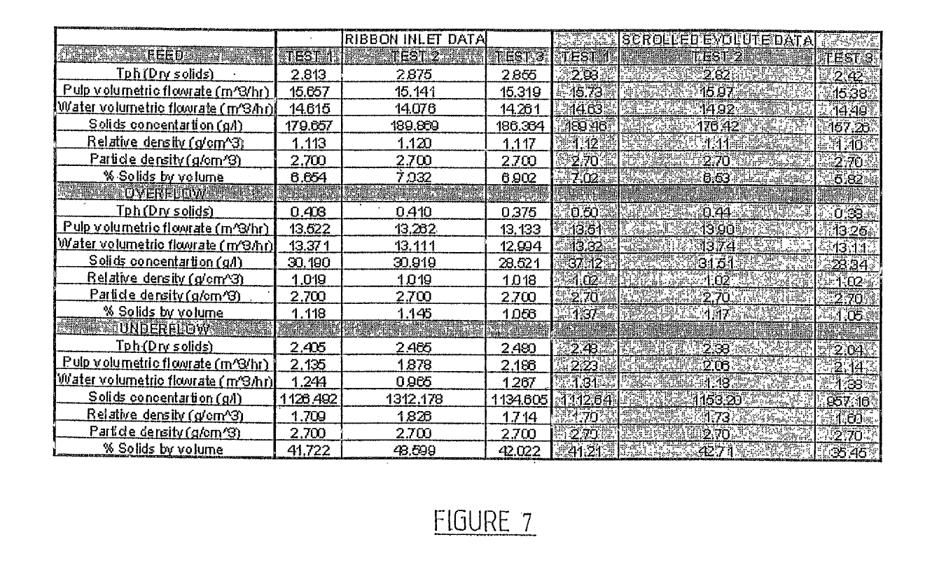

The table shown in FIG. 7 shows comparative data between the cyclone of the invention and that of a scrolled evolute cyclone. It will be understood that a scrolled evolute cyclone is a relatively high cost, high performance prior art cyclone. It will be noted from the data that the cyclone of the invention is at least equal in performance to that of the scrolled evolute cyclone.

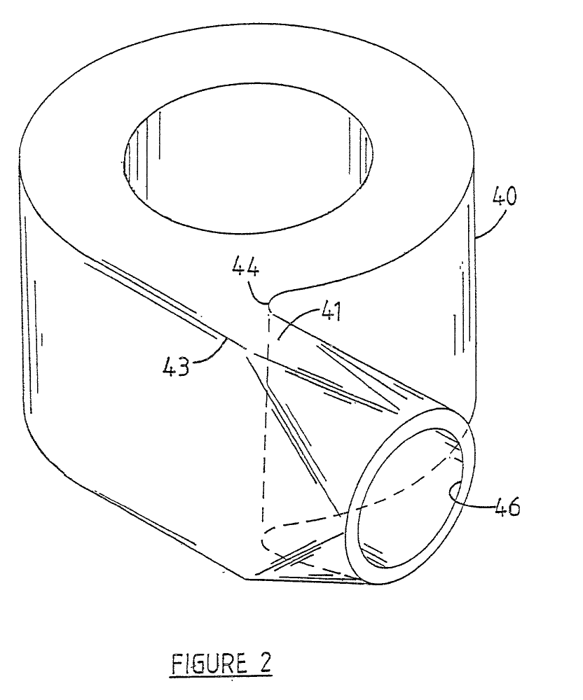

The invention further provides for the inlet duct 46 to transform from a substantially circular profile in cross-section, to the shape of the elongated slot 41 along a transformation zone 45, FIG. 3. It is intended that such transformation will be sufficiently gradual to minimize turbulence.

The arrangement of the invention provides a cyclone 30 which is relatively cost effective to produce, while providing high performance. The advantages of the enhanced performance of a cyclone in accordance with the invention, will be apparent to persons skilled in the art.

Doubtless variations of the invention exist without departing from the principles set out in the consistory clauses. For example, the inlet head 40 and inlet duct 46 of the invention could be utilized with numerous combinations of vortex finders 16, cone structures 13, 14, and outlet configurations 15, and it is intended that these combinations will all fall within the scope of the present invention.

1. A cyclone comprising a generally cylindrical inlet head into which a vortex finder extends co-axially, and from which a tubular section extends opposed to the vortex finder, a generally tangentially disposed inlet for introducing raw material into the inlet head, the tangential inlet being elongated at the zone of its junction with the inlet head to define a major outer wall and a major inner wall, the major outer wall merging with the wall of the cylindrical inlet head generally tangentially at such junction, while the major inner wall diverges towards the axis of the inlet head at each junction.

2. The cyclone according to claim 1 wherein the major inner wall diverges through a curvature or radius at the junction with the wall of the inlet head.

3. The cyclone according to claim 1 wherein the elongated inlet has a length to width ratio of between 2 to 1 and 10 to 1.

4. The cyclone according to claim 3 wherein the elongated inlet has a length to width ratio of 5 to 1.

5. The cyclone according to claim 1 wherein the elongated inlet is of a rectilinear shape.

6. The cyclone according to claim 2 wherein the ratio of the diameter of the inlet head in relation to the curvature or radius of the major inner wall of the inlet is between 5 to 1 and 100 to 1.

7. The cyclone according to claim 6 wherein the ratio of the diameter of the inlet head in relation to the curvature or radius of the major inner wall of the inlet is 20 to 1.
